(19) United States
(12) Patent Application Publication
(10) Pub. No.: US 2019/0301286 A1
(43) Pub. Date: Oct. 3, 2019

(54) AIRFOILS FOR GAS TURBINE ENGINES

(71) Applicant: United Technologies Corporation, Farmington, CT (US)

(72) Inventors: Brandon W. Spangler, Vernon, CT (US); Corey D. Anderson, East Hartford, CT (US)

(21) Appl. No.: 15/938,062

(22) Filed: Mar. 28, 2018

(51) Int. Cl. F01D 5/18; F01D 5/14; F01D 9/04

(52) U.S. Cl. CPC F01D 5/189; F01D 5/147; F01D 9/041; F05D 2260/201; F05D 2240/301; F05D 2240/306; F05D 2240/126; F05D 2240/122; F05D 2240/123; F05D 2240/124; F05D 2240/305; F05D 2240/304

(57) ABSTRACT

Airfoils for gas turbine engines are provided. The airfoil include an airfoil body, the body extending between a leading edge and a trailing edge in an axial direction and between a pressure side wall and a suction side wall in a circumferential direction, the airfoil body defining an airfoil cavity therein and a baffle located within the airfoil cavity. The airfoil includes increased thickness side walls to form an airfoil cavity to account for the baffle within the cavity and to direct cooling flow through the airfoil.

### STATEMENT REGARDING FEDERALLY SPONSORED RESEARCH OR DEVELOPMENT

This invention was made with government support under Contract No. W58RGZ-16-C-0046 awarded by the United States Army. The Government has certain rights in this invention.

### BACKGROUND

The subject matter disclosed herein generally relates to cooling flow in airfoils of gas turbine engines and, more particularly, to airfoils having modified structure to improve part life.

In gas turbine engines, cooling air may be configured to flow through an internal cavity of an airfoil to prevent overheating. In order to utilize cooling flow efficiently, small cavities that generate high heat transfer are desired. Previously, this has been accomplished using baffles, referred to herein as “space-eater” baffles, to occupy some of the space within the internal cavity and reduce the height of the internal cavity. These baffles are typically formed into a desired shape by bending sheet metal and, as such, require a minimum bend radius that is approximately two times the sheet metal thickness. In order to maintain the desired high heat transfer for as long as possible, the space eater baffles generally extend aft as far as they can before terminating in this minimum bend radius. As such, the height of the cavity after of the baffle is slightly larger than the channel height at the baffle. This change in cavity height is typically managed through the use and modification of heat transfer features and/or by a slight increase in the thickness of airfoil walls after the baffle.

However, in some arrangements, the baffles may be restricted in an axial extent within an airfoil cavity, resulting in portions of cavities having large heights, and thus reduced cooling efficiencies. In addition, the rapid change in cavity height from the baffle region to the region aft of the baffle can result in large separation eddies that induce significant pressure drop. Thus, it is desirable to provide means of controlling the heat transfer and pressure loss in airfoils of gas turbine engines, particularly within airfoils having restricted baffle arrangements.

### SUMMARY

According to some embodiments, airfoils for gas turbine engines are provided. The airfoils include an airfoil body, the body extending between a leading edge and a trailing edge in an axial direction and between a pressure side wall and a suction side wall in a circumferential direction, the airfoil body defining an airfoil cavity therein and a baffle located within the airfoil cavity. The airfoil cavity includes a first channel defined between the baffle and a pressure side interior surface of the airfoil body, wherein the first channel has a first channel height H₁ defined as a distance between the baffle and the pressure side interior surface, a second channel defined between the baffle and a suction side interior surface of the airfoil body, wherein the second channel has a second channel height H₂ defined as a distance between the baffle and the suction side interior surface, and a third channel aft of the baffle and defined between the pressure side interior surface and the suction side interior surface, wherein the third channel has a third channel height H₃ defined as a distance between the pressure side interior surface and the suction side interior surface. A trailing edge of the baffle has a height H₄, wherein

$$\frac{{H}_{4}}{( 0.5 * ( {H}_{1} + {H}_{2} ) )} > 3.$$

In addition to one or more of the features described above, or as an alternative, further embodiments of the airfoils may include that the airfoil body has a first wall thickness T₁, a second wall thickness T₂, a third wall thickness T₃, and fourth wall thickness T₄, wherein the first wall thickness is a portion of the airfoil body defining the first channel, the second wall thickness is a portion of the airfoil body defining the second channel, and the third and fourth wall thicknesses are portions of the airfoil body defining the third channel.

In addition to one or more of the features described above, or as an alternative, further embodiments of the airfoils may include that at least one of T₃/T₁ and T₄/T₂ is between 1.25 and 3.

In addition to one or more of the features described above, or as an alternative, further embodiments of the airfoils may include that the at least one of the pressure side wall and the suction side wall includes a wall transition section located between portions of the airfoil defining the respective first channel or second channel and the third channel.

In addition to one or more of the features described above, or as an alternative, further embodiments of the airfoils may include that

$$\frac{{H}_{3}}{( {H}_{1} + {H}_{2} )}$$

is between 0.5 and 1.5.

In addition to one or more of the features described above, or as an alternative, further embodiments of the airfoils may include that the third channel has smooth walls on both the pressure and suction sides of the third channel.

In addition to one or more of the features described above, or as an alternative, further embodiments of the airfoils may include that

$$\frac{{H}_{3}}{( {H}_{1} + {H}_{2} )}$$

is between 0.5 and 1.2.

In addition to one or more of the features described above, or as an alternative, further embodiments of the airfoils may include that in the third channel has at least one heat transfer augmentation feature on one of the pressure side wall and the suction side wall defining the third channel.

In addition to one or more of the features described above, or as an alternative, further embodiments of the airfoils may include that

$$\frac{{H}_{3}}{( {H}_{1} + {H}_{2} )}$$

is between 0.75 and 1.25.

In addition to one or more of the features described above, or as an alternative, further embodiments of the airfoils may include that the third channel has at least one heat transfer augmentation feature on each of the pressure side wall and the suction side wall defining the third channel.

In addition to one or more of the features described above, or as an alternative, further embodiments of the airfoils may include that

$$\frac{{H}_{3}}{( {H}_{1} + {H}_{2} )}$$

is between 1.0 and 1.5.

In addition to one or more of the features described above, or as an alternative, further embodiments of the airfoils may include that the airfoil cavity having the baffle is a first airfoil cavity, the airfoil body further defining a second airfoil cavity.

In addition to one or more of the features described above, or as an alternative, further embodiments of the airfoils may include that the second airfoil cavity is located aft of the first airfoil cavity and separated therefrom by an impingement rib.

In addition to one or more of the features described above, or as an alternative, further embodiments of the airfoils may include that the third channel is located between the baffle and the impingement rib.

In addition to one or more of the features described above, or as an alternative, further embodiments of the airfoils may include that the airfoil body defines a body of a vane of a gas turbine engine.

In addition to one or more of the features described above, or as an alternative, further embodiments of the airfoils may include that the airfoil body defines a body of a blade of a gas turbine engine.

According to some embodiments, gas turbine engines are provided. The gas turbine engine include a turbine section having a blade and a vane. At least one of the blade and the vane includes an airfoil body, the body extending between a leading edge and a trailing edge in an axial direction and between a pressure side and a suction side in a circumferential direction, the airfoil body defining an airfoil cavity therein and a baffle located within the airfoil cavity. The airfoil cavity includes a first channel defined between the baffle and a pressure side interior surface of the airfoil body, wherein the first channel has a first channel height H₁ defined as a distance between the baffle and the pressure side interior surface, a second channel defined between the baffle and a suction side interior surface of the airfoil body, wherein the second channel has a second channel height H₂ defined as a distance between the baffle and the suction side interior surface, and a third channel aft of the baffle and defined between the pressure side interior surface and the suction side interior surface, wherein the third channel has a third channel height H₃ defined as a distance between the pressure side interior surface and the suction side interior surface. A trailing edge of the baffle has a height H4, wherein

$$\frac{{H}_{4}}{( 0.5 * ( {H}_{1} + {H}_{2} ) )} > 3.$$

In addition to one or more of the features described above, or as an alternative, further embodiments of the gas turbine engines may include that the airfoil body has a first wall thickness T1, a second wall thickness T2, a third wall thickness T3, and fourth wall thickness T4, wherein the first wall thickness is a portion of the airfoil body defining the first channel, the second wall thickness is a portion of the airfoil body defining the second channel, and the third and fourth wall thicknesses are portions of the airfoil body defining the third channel, and wherein at least one of

$$\frac{{T}_{3}}{{T}_{1}} and \frac{{T}_{4}}{{T}_{2}}$$

is between 1.25 and 3.

In addition to one or more of the features described above, or as an alternative, further embodiments of the gas turbine engines may include that the at least one of the pressure side wall and the suction side wall includes a wall transition section located between portions of the airfoil defining the respective first channel or second channel and the third channel.

In addition to one or more of the features described above, or as an alternative, further embodiments of the gas turbine engines may include that

$$\frac{{H}_{3}}{( {H}_{1} + {H}_{2} )} = \{ \begin{matrix}0.5 to 1.2 , smooth walls of the third channel \\ 0.75 to 1.25 , features on one wall of the third channel \\ 1.0 to 1.5 , features on both walls of the third channel\end{matrix} .$$

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic cross-sectional view of a gas turbine engine that may employ various embodiments disclosed herein;

FIG. 2 is a partial schematic view of a portion of a turbine section of a gas turbine engine of that may employ various embodiments of the present disclosure;

FIG. 3A is a schematic illustration of an airfoil that may incorporate embodiments of the present disclosure;

FIG. 3B is a cross-sectional illustration of the airfoil of FIG. 3A as viewed along the line 3B-3B thereof;

FIG. 4 is a schematic illustration of an airfoil in accordance with an embodiment of the present disclosure;

FIG. 5 is a schematic illustration of an airfoil in accordance with an embodiment of the present disclosure;

FIG. 6 is a schematic illustration of an airfoil in accordance with an embodiment of the present disclosure;

FIG. 7 is a schematic illustration of an airfoil in accordance with an embodiment of the present disclosure; and

FIG. 8 is a schematic illustration of an airfoil in accordance with an embodiment of the present disclosure.

### DETAILED DESCRIPTION

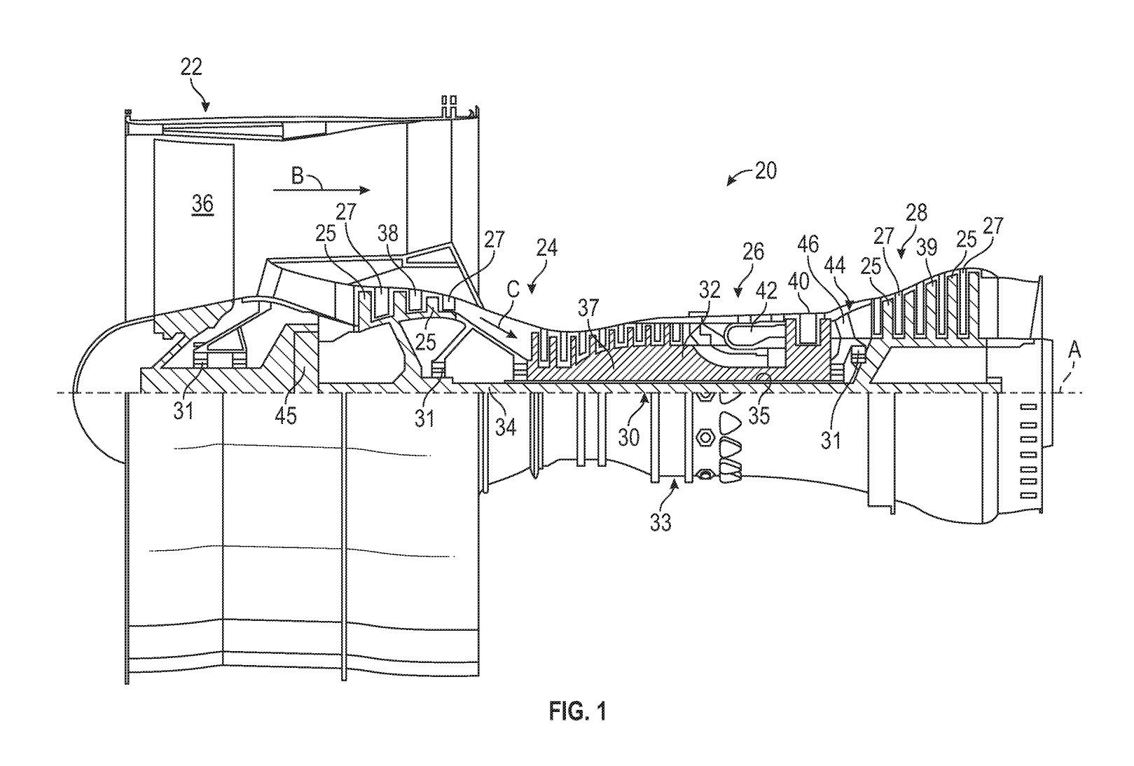

FIG. 1 schematically illustrates a gas turbine engine 20. The exemplary gas turbine engine 20 is a two-spool turbofan engine that generally incorporates a fan section 22, a compressor section 24, a combustor section 26, and a turbine section 28. Alternative engines might include an augmenter section (not shown) among other systems for features. The fan section 22 drives air along a bypass flow path B, while the compressor section 24 drives air along a core flow path C for compression and communication into the combustor section 26. Hot combustion gases generated in the combustor section 26 are expanded through the turbine section 28. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

The gas turbine engine 20 generally includes a low speed spool 30 and a high speed spool 32 mounted for rotation about an engine centerline longitudinal axis A. The low speed spool 30 and the high speed spool 32 may be mounted relative to an engine static structure 33 via several bearing systems 31. It should be understood that other bearing systems 31 may alternatively or additionally be provided.

The low speed spool 30 generally includes an inner shaft 34 that interconnects a fan 36, a low pressure compressor 38 and a low pressure turbine 39. The inner shaft 34 can be connected to the fan 36 through a geared architecture 45 to drive the fan 36 at a lower speed than the low speed spool 30. The high speed spool 32 includes an outer shaft 35 that interconnects a high pressure compressor 37 and a high pressure turbine 40. In this embodiment, the inner shaft 34 and the outer shaft 35 are supported at various axial locations by bearing systems 31 positioned within the engine static structure 33.

A combustor 42 is arranged between the high pressure compressor 37 and the high pressure turbine 40. A mid-turbine frame 44 may be arranged generally between the high pressure turbine 40 and the low pressure turbine 39. The mid-turbine frame 44 can support one or more bearing systems 31 of the turbine section 28. The mid-turbine frame 44 may include one or more airfoils 46 that extend within the core flow path C.

The inner shaft 34 and the outer shaft 35 are concentric and rotate via the bearing systems 31 about the engine centerline longitudinal axis A, which is co-linear with their longitudinal axes. The core airflow is compressed by the low pressure compressor 38 and the high pressure compressor 37, is mixed with fuel and burned in the combustor 42, and is then expanded over the high pressure turbine 40 and the low pressure turbine 39. The high pressure turbine 40 and the low pressure turbine 39 rotationally drive the respective high speed spool 32 and the low speed spool 30 in response to the expansion.

The pressure ratio of the low pressure turbine 39 can be pressure measured prior to the inlet of the low pressure turbine 39 as related to the pressure at the outlet of the low pressure turbine 39 and prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 38, and the low pressure turbine 39 has a pressure ratio that is greater than about five (5:1). It should be understood, however, that the above parameters are only examples of one embodiment of a geared architecture engine and that the present disclosure is applicable to other gas turbine engines, including direct drive turbofans.

In this embodiment of the example gas turbine engine 20, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of [(Tᵣₐₘ° R)/(518.7° R)]^{0.5}, where T represents the ambient temperature in degrees Rankine. The Low Corrected Fan Tip Speed according to one non-limiting embodiment of the example gas turbine engine 20 is less than about 1150 fps (351 m/s).

Each of the compressor section 24 and the turbine section 28 may include alternating rows of rotor assemblies and vane assemblies (shown schematically) that carry airfoils that extend into the core flow path C. For example, the rotor assemblies can carry a plurality of rotating blades 25, while each vane assembly can carry a plurality of vanes 27 that extend into the core flow path C. The blades 25 of the rotor assemblies create or extract energy (in the form of pressure) from the core airflow that is communicated through the gas turbine engine 20 along the core flow path C. The vanes 27 of the vane assemblies direct the core airflow to the blades 25 to either add or extract energy.

Various components of a gas turbine engine 20, including but not limited to the airfoils of the blades 25 and the vanes 27 of the compressor section 24 and the turbine section 28, may be subjected to repetitive thermal cycling under widely ranging temperatures and pressures. The hardware of the turbine section 28 is particularly subjected to relatively extreme operating conditions. Therefore, some components may require internal cooling circuits for cooling the parts during engine operation. Example cooling circuits that include features such as partial cavity baffles are discussed below.

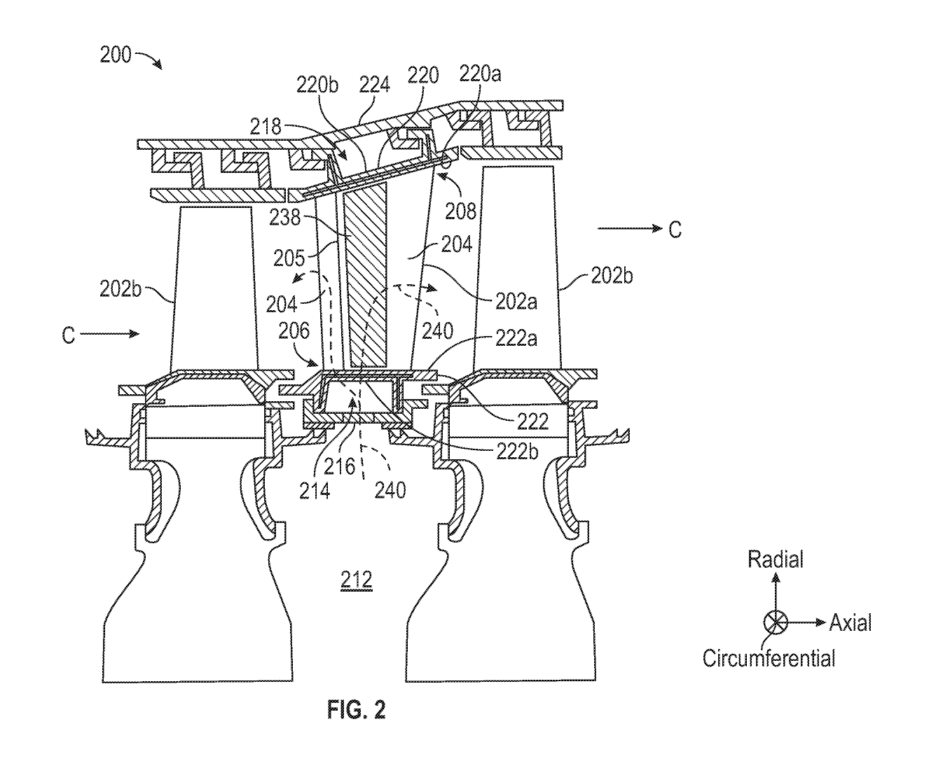

FIG. 2 is a partial schematic view of a turbine section 200 that may be part of the gas turbine engine 20 shown in FIG. 1. Turbine section 200 includes one or more airfoils 202a, 202b. As shown, some airfoils 202a are stationary stator vanes and other airfoils 202b are blades of turbines disks. The airfoils 202a, 202b, in accordance with embodiments of the present disclosure, are hollow body airfoils with one or more internal cavities defining a number of cooling channels 204 (schematically shown in vane 202a). The airfoil cavities 204 are formed within the airfoils 202a, 202b and extend from an inner diameter 206 to an outer diameter 208, or vice-versa. The airfoil cavities 204, as shown in the vane 202a, may be separated by partitions 205 that extend along a radial direction of the respective airfoil, e.g., from the inner diameter 206 or the outer diameter 208 of the vane 202a. Those of skill in the art will appreciate that the partitions 205 that separate and define the airfoil cavities 204 are not usually visible and FIG. 2 is merely presented for illustrative and explanatory purposes. Although not shown, those of skill in the art will appreciate that the blades 202b can include similar cooling passages formed by partitions therein.

The airfoil cavities 204 are configured for cooling airflow to pass through portions of the vane 202a and thus cool the vane 202a. For example, as shown in FIG. 2, an airflow path 240 is indicated by a dashed line. In the configuration of FIG. 2, air flows from a rotor cavity 212 and into an airfoil inner diameter cavity 214 through an orifice 216. The air then flows into and through the airfoil cavities 204 as indicated by the airflow path 240. Positioned at the outer diameter of the vane 202a, as shown, is an outer diameter cavity 218. Although shown with the airflow path 240 originating at an inner diameter, those of skill in the art will appreciate that a cooling airflow can be supplied from an outer diameter (e.g., from the outer diameter cavity 218) or from a combination of inner and outer diameter cavities.

As shown in FIG. 2, the vane 202a includes an outer diameter platform 220 and an inner diameter platform 222. The platforms 220, 222 are configured to enable attachment within and to the gas turbine engine. For example, as appreciated by those of skill in the art, the inner diameter platform 222 can be mounted between adjacent rotor disks and the outer diameter platform 220 can be mounted to a case 224 of the gas turbine engine.

As shown, the outer diameter cavity 218 is formed between the case 224 and the outer diameter platform 220. Those of skill in the art will appreciate that the outer diameter cavity 218 and the inner diameter cavity 214 are outside of or separate from a core flow path C (e.g., a hot gas path). The cavities 214, 218 are separated from the core flow path C by the platforms 220, 222. Thus, each platform 220, 222 includes a respective core gas path surface 220a, 222a and a non-gas path surface 220b, 222b.

A body of the vane 202a, which defines the airfoil cavities 204 therein and forms the shape and exterior surfaces of the vane 202a extends from and between the gas path surfaces 220a, 222a of the respective platforms 220, 222. In some embodiments, the platforms 220, 222 and the body of the vane 202a are formed as a unitary body or structure. In other embodiments, the vane body may be attached to the platforms, as will be appreciated by those of skill in the art.

Air is passed through the airfoil cavities of the airfoils to provide cooling airflow to prevent overheating of the airfoils and/or other components or parts of the gas turbine engine. The flow rate through the airfoil cavities may be a relatively low flow rate of air and because of the low flow rate, the convective cooling and resultant internal heat transfer coefficient may be too low to achieve desired metal temperatures of the airfoils. One solution to address the low flow rate within the airfoil cavities is to add one or more baffles 238 into the airfoil cavities. That is, in order to achieve desired metal temperatures to meet airfoil full-life with the cooling flow allocated based on turbine engine design, “space-eater” baffles 238 may be used inside airfoil cooling passages (e.g., within the airfoil cavities 204 shown in FIG. 2).

The “space-eater” baffle serves as a way to consume internal cavity area/volume in order to reduce the available cross-sectional area through which air can flow. This enables the local flow per unit area to be increased which in turn results in higher cooling cavity Reynolds Numbers and internal convective heat transfer. In some circumstances, depending upon the method of manufacture, the radial cooling cavities 204 must be accessible to allow for the insertion of the “space-eater” baffles. However, those of skill in the art will appreciate that if the airfoil cooling configurations are fabricated using alternative additive manufacturing processes and/or fugitive core casting processes the “space-eater” baffles may be fabricated as an integral part or component of the internal convective cooling design concurrently with the rest of the core body and cooling circuit.

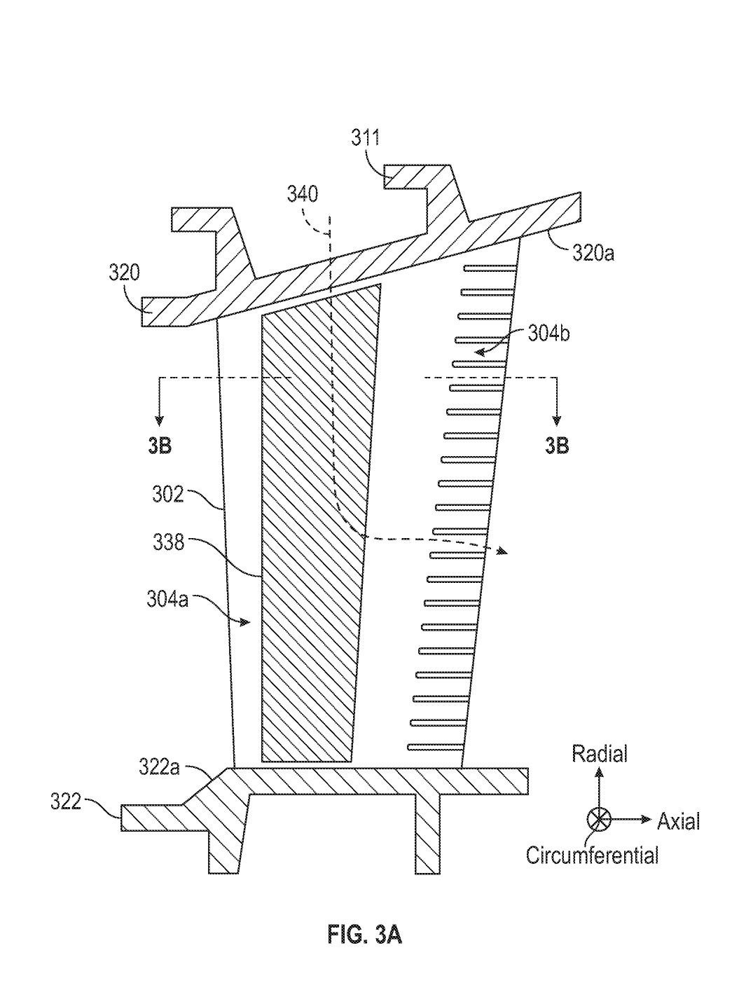

Turning now to FIG. 3A, a schematic illustration of an airfoil 302 that can incorporate embodiments of the present disclosure is shown. The airfoil 302 may be a blade or vane and, similar to that shown and described above, includes an airfoil body that extends from an inner diameter platform 322 to an outer diameter platform 320. Specifically, the body of the airfoil 302 extends from a gas path surface 320a of the outer diameter platform 320 to a gas path surface 322a of the inner diameter platform 322.

The airfoil 302 includes one or more interior airfoil cavities, as shown having an airfoil cavity 304a fluidly connected to a trailing edge cavity 304b. As illustratively shown, a cooling flow of air can follow an airflow path 340 by entering the airfoil 302 from the outer diameter and out through the trailing edge cavity 304b. As shown, the airfoil cavity 304a is configured with a baffle 338 inserted therein.

During part assembly, baffles must be inserted into the interior airfoil cavities via the inner diameter or the outer diameter, e.g., through openings at ends of the airfoil body. Typically, the vane rails (e.g., for connecting to a case of a gas turbine engine) may inhibit insertion of the baffles which can limit an axial length of the baffle. For example, the aft length (or axial extent) of a baffle may be constrained by the presence of an outer diameter rail 311.

As can be seen in FIG. 3B, which is a cross-sectional view of FIG. 3A as viewed along the line 3B-3B, a cooling cavity height is controlled by the baffle-to-airfoil-wall offsets H₁, H₂, with smaller heights being preferable. However, when a rail, such as outer diameter rail 311, prevents a full axial-length baffle, the trailing edge of the baffle becomes blunt, creating a large baffle trailing edge height H₄. This, in turn, creates a height of the cooling passage aft of the baffle H₃ that is very large because it is no longer constrained by the baffle and is merely an open airfoil cavity with the height of the cavity defined by opposing airfoil walls (e.g., no baffle to shorten the height), resulting in reduced heat transfer. In addition, the rapid change in cavity height from the baffle region H₁, H₂ to the region aft of the baffle H₃ can result in large separation eddies 342 immediately downstream of the baffle that induce significant pressure loss.

Accordingly, embodiments provided herein are directed to airfoils having modified structure to allow for baffle insertion while also preventing losses downstream of the inserted baffled. For example, in accordance with embodiments described herein, an airfoil wall thickness is increased downstream of an airfoil baffle cavity to reduce the height of the cooling passage. Such increased wall thickness may result in higher coolant Mach numbers, improved convective heat transfer coefficient, and reduced pressure losses. As such, part life may be increased.

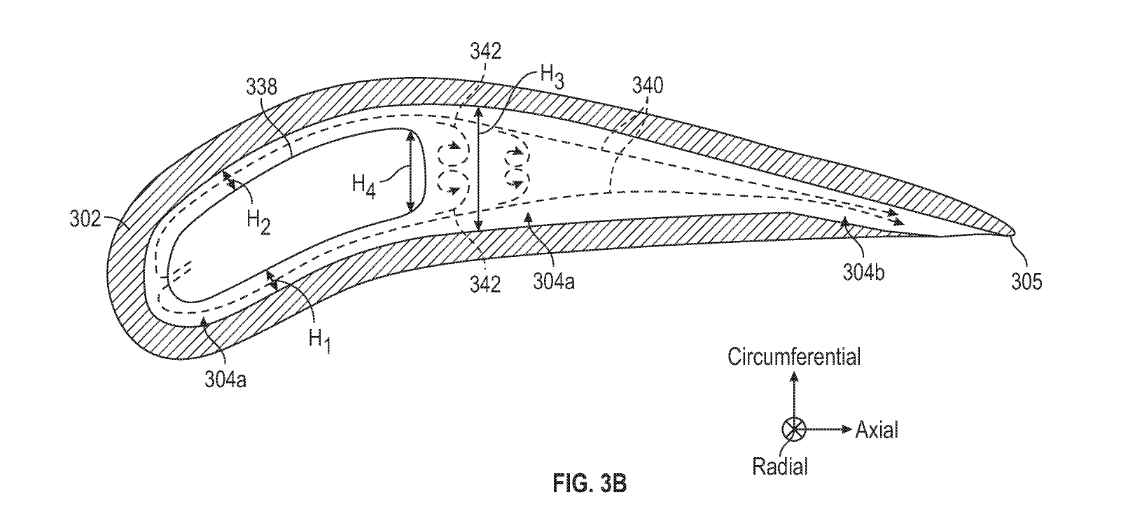

Turning now to FIG. 4, a schematic illustration of an airfoil 400 in accordance with an embodiment of the present disclosure is shown. The airfoil 400 has an airfoil body 402 that extends in an axial direction between a leading edge 404 and a trailing edge 405. In the circumferential direction the airfoil body 402 extends between a pressure side 406 and a suction side 408. The airfoil body 402 has a pressure side wall 410 and a suction side wall 412. The side walls 410, 412 define one or more interior cavities and define a pressure side exterior hot surface 414 and a suction side exterior hot surface 416, respectively. In this illustrative embodiment, a single internal airfoil cavity 418 extends axially from the leading edge 404 to the trailing edge 405 on the interior of the airfoil body 402. A baffle 420 is positioned within the airfoil cavity 418. The baffle 420 has a baffle trailing edge height H₄, as measured in the circumferential direction, that is much larger than the first and second channel heights H₁, H₂.

With the baffle 420 installed within the airfoil 400, the airfoil cavity 418 is arranged to have a first channel 422, a second channel 424, and a third channel 426, as described herein. The first channel 422 of the airfoil cavity 418 is defined as a channel of the airfoil cavity 418 defined between the baffle 420 and a pressure side interior surface 428, and has a first channel height H₁. The second channel 424 of the airfoil cavity 418 is defined as a channel of the airfoil cavity 418 defined between the baffle 420 and a suction side interior surface 430, and has a second channel height H₂. Aft of the baffle 420, the first channel 422 and the second channel 424 merge to form the third channel 426, which is defined between the pressure side interior surface 428 and the suction side interior surface 430. Although shown schematically with the interior surfaces of the airfoil cavity as “smooth” (i.e., not having features thereon), those of skill in the art will appreciate that the surfaces or portions thereof may include one or more thermal or heat transfer augmentation features (e.g., trip strips, pedestals, etc.). Further, although the walls of the airfoil are shown as solid, those of skill in the art will appreciate that one or more film cooling holes may be formed therein.

As shown, the airfoil body 402 has different wall thicknesses along the axial length of the airfoil body 402. For example, as shown, a first wall thickness T₁ is formed as part of the pressure side wall 410 at the location of the baffle 420 and allows for the first channel height H₁ of the airfoil cavity 418 to be defined. A second wall thickness T₂ is formed as part of the suction side wall 412 at the location of the baffle 420 and allows for the second channel height H₂ of the airfoil cavity 418 to be defined. Aft of the baffle 420, and defining the third channel 426 of the airfoil cavity 418, are increased wall thicknesses, with a third wall thickness T₃ being a pressure side wall thickness and a fourth wall thickness T₄ being a suction side wall thickness. As shown, wall transition sections 432, 434 are formed along the airfoil side walls 410, 412 between the portions having the first wall thickness T₁ and the third wall thickness T₃ and the second wall thickness T₂ and fourth wall thickness T₄, respectively. The wall transition sections 432, 434 are configured to smoothly transition from one wall thickness to another and to direct a cooling flow 440 behind the baffle 420 to eliminate or reduce the large separation eddies (shown in FIG. 3B), resulting in lower pressure loss. The wall transition sections 432, 434 and thickened walls may be particularly useful in eliminating the large eddies and increasing heat transfer along the third channel 426 when the baffle trailing edge height H₄ is much larger than first and second channel heights H₁, H₂, such as in a first constraint equation C1:

$$\frac{{H}_{4}}{( 0.5 * ( {H}_{1} + {H}_{2} ) )} > 3 \qquad ( C1 )$$

With the modified wall thicknesses and defined internal airfoil cavity, a standard baffle can be installed therein, while maintaining desired cooling characteristics. That is, the third channel 426 of the airfoil cavity 418 shown, downstream of the baffle 420 enables desired fluid flow and cooling properties to enable increased part life.

The third and fourth wall thicknesses T₃, T₄ may be adjusted or configured to control the third channel height H₃ of the third channel 426 of the airfoil cavity 418, and as such, may vary along the length of the third channel 426. Further, the first channel height H₁ and the second channel height H₂ govern the cooling flow characteristics in the channels 422, 424 located beside or along the baffle 420. In some embodiments, the first channel height H₁, the second channel height H₂, and the third channel height H₃ may all be equal. However, in some embodiments, the various channel heights H₁, H₂, H₃ may be different from each other to achieve specific flow and/or cooling (e.g., heat transfer) characteristics.

As noted above, aft of a typical baffle, the channel height of the airfoil cavity increases resulting in reduced flow velocity and reduced heat transfer coefficient, which in turn may result in higher metal temperatures. However, in accordance with embodiments of the present disclosure, by increasing the airfoil wall thickness (e.g., third thickness T₃ and fourth thickness T₄), the third channel height H₃ can be reduced, thus increasing cooling velocity, increasing heat transfer, and resulting in part metal temperatures that are more uniform and/or required to allow the part to meet life requirements.

In accordance with embodiments of the present disclosure, various relationships between the channel heights and/or wall thicknesses may be provided which define the respective heights and/or thicknesses. In some embodiments, the third channel height H₃ of the third channel 426 may be proportional or near proportional with the sum of the first and second channel heights H₁, H₂ of the first and second channels 422, 424 (i.e., H₃∝H₁+H₂).

A second constraint equation (C2) may be employed in situations where the wall thickening is particularly considered. The second constraint provides a quantifier for how much ‘thicker’ the metal walls are aft of the location of the baffle:

$$\frac{{T}_{3}}{{T}_{1}} or \frac{{T}_{4}}{{T}_{2}} is between 1.25 \to 3 \qquad ( C2 )$$

It will be appreciated by those of skill in the art, in view of the teachings herein, that the walls aft of the baffle should be thick enough to manage the heat transfer of the third channel, but not too thick as to cause a thermal fight between the thin walls (having thicknesses T₁, T₂) and the thick walls (having thicknesses T₃, T₄).

A third constraint equation (C3) can be employed for various different scenarios. As will be appreciated by those of skill in the art, higher fluid velocities means higher heat transfer coefficient. Heat transfer coefficient can also be augmented by implementing heat-transfer augmentation features (e.g., trip strips, pedestals, etc.). A certain internal heat transfer coefficient may be desired to meet metal temperature (and thus part-life) requirements. The third constraint (C3) provides a relationship between the different channel heights H₁, H₂, H₃:

$$\frac{{H}_{3}}{( {H}_{1} + {H}_{2} )} = \{ \begin{matrix}0.5 to 1.2 , smooth wall \\ 0.75 to 1.25 , features on one wall \\ 1.0 to 1.5 , features on two walls\end{matrix} \qquad ( C3 )$$

In accordance with the third constraint (C3), if the third channel 426 is smooth-walled (i.e., no features on the pressure side interior surface 428 or the suction side interior surface 430 along the third channel 426), the constraint ratio must be small to account for the lack of heat transfer augmentation features. However, if the third channel 426 has heat transfer features on one wall (i.e., one of the pressure side interior surface 428 or the suction side interior surface 430 along the third channel 426) the constraint ratio can be larger because the heat transfer coefficient is augmented by these features. Moreover, if the third channel 426 has heat transfer features on both walls (i.e., both of the pressure side interior surface 428 or the suction side interior surface 430 along the third channel 426) the constraint ratio can be even larger because the heat transfer augmentation is even greater.

The airfoil and baffle arrangement described herein can be employed in any type of airfoil, including both blades and vanes of gas turbine engines. Further different configurations may be employed with respect to the axial restrictions based on different engine configurations.

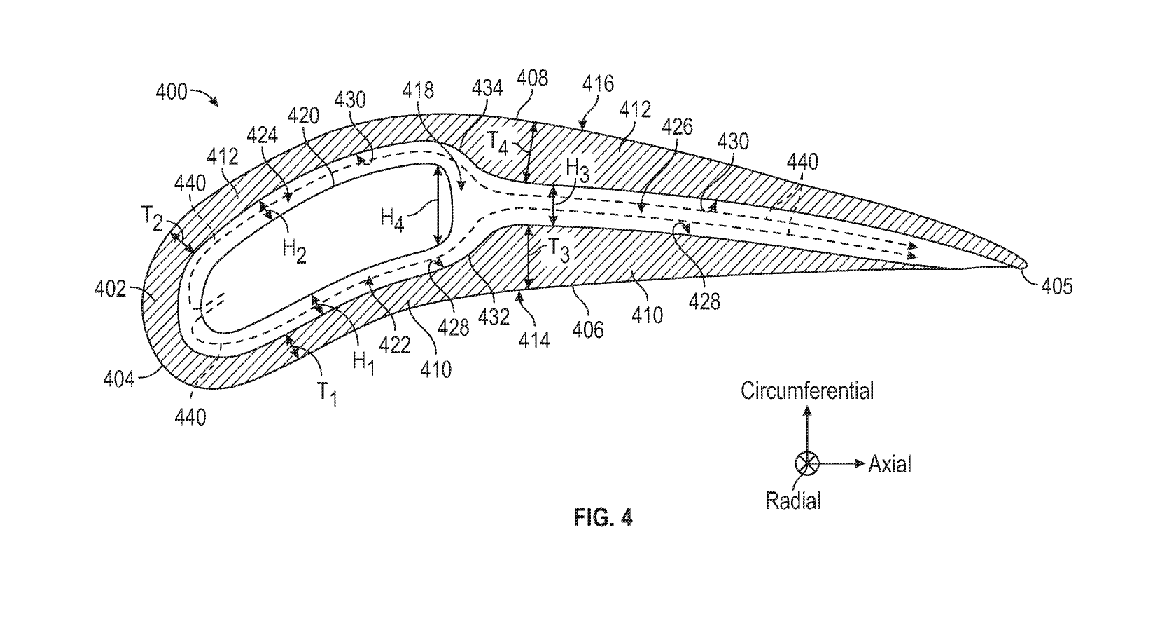

For example, turning to FIG. 5, an airfoil 500 is shown with an unrestricted baffle 502 installed therein. In this embodiment, the baffle 502 is unrestricted because of the position and orientation of outer diameter rails 504 and inner diameter rails 506. However, even without such restrictions, the airfoil 500 may still include a modified airfoil cavity region 508 aft of the baffle that includes increased wall thickness airfoil body walls, similar to that shown and described above.

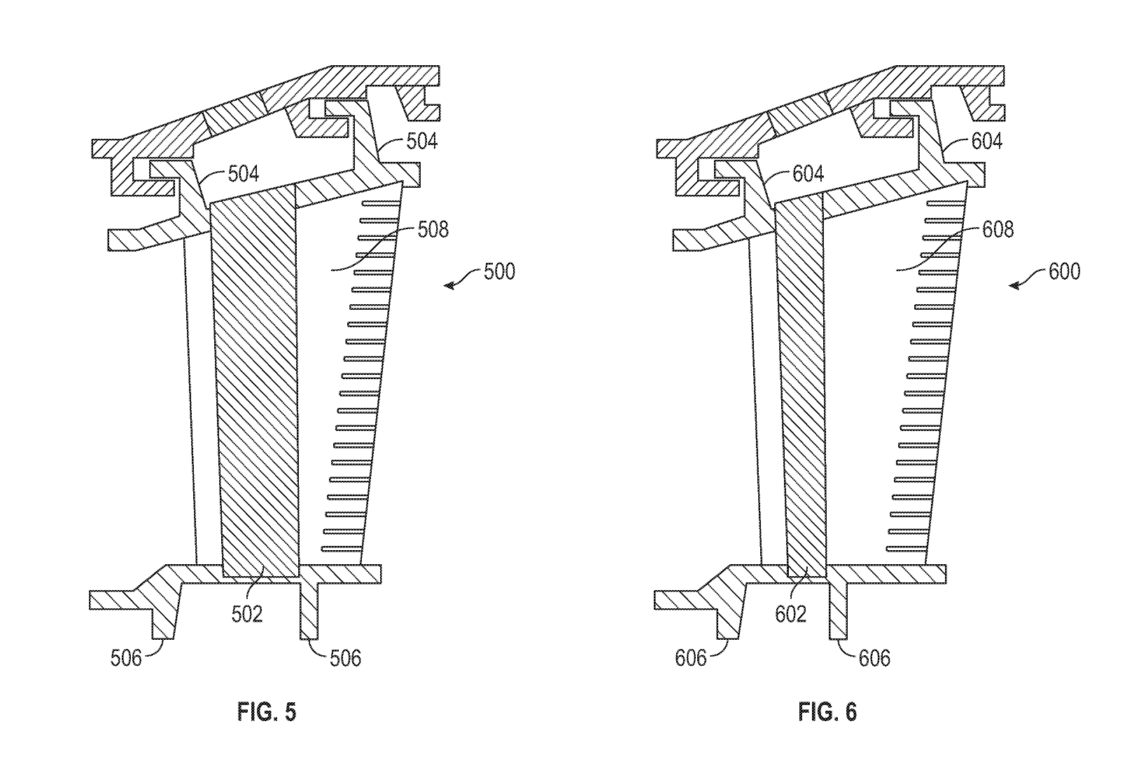

In contrast, turning to FIG. 6, an airfoil 600 is shown with a restricted baffle 602 installed therein. In this embodiment, the baffle 602 is restricted because of the position and orientation of inner diameter rails 606, with outer diameter rails 604 not providing a restriction. Due to the restriction, the airfoil 600 includes a modified airfoil cavity region 608 aft of the baffle that includes increased wall thickness airfoil body walls, similar to that shown and described above. The modified airfoil cavity region 608 of FIG. 6 has a larger/longer axial extent than arrangement shown in FIG. 5, and the baffle 602 has a smaller/shorter axial extent than the arrangement shown in FIG. 5.

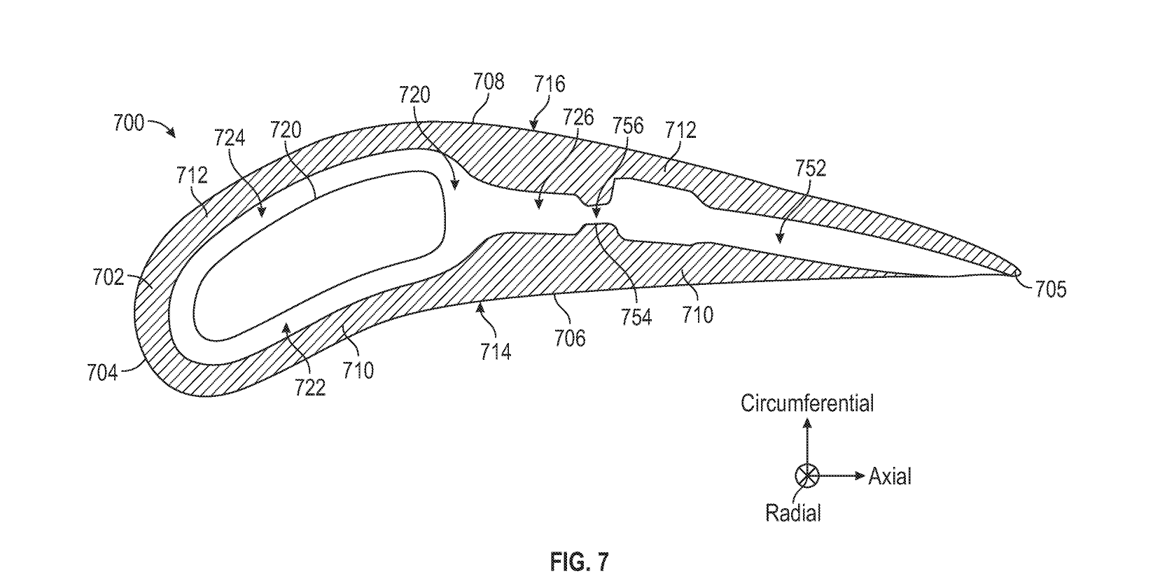

Turning now to FIG. 7, a schematic illustration of an airfoil 700 in accordance with an embodiment of the present disclosure is shown. The airfoil 700 has an airfoil body 702 that extends in an axial direction between a leading edge 704 and a trailing edge 705. In the circumferential direction the airfoil body 702 extends between a pressure side 706 and a suction side 708. The airfoil body 702 has a pressure side wall 710 and a suction side wall 712. The side walls 710, 712 define one or more interior cavities and define a pressure side exterior hot surface 714 and a suction side exterior hot surface 716, respectively. In this illustrative embodiment, the airfoil 700 includes a first airfoil cavity 750 that extends axially from the leading edge 704 and a second airfoil cavity 752 that extends to the trailing edge 705 on the interior of the airfoil body 702. A baffle 720 is positioned within the first airfoil cavity 750 and an impingement rib 754 having one or more impingement holes 756 fluidly connecting the first airfoil cavity 750 to the second airfoil cavity 752.

With the baffle 720 installed within the airfoil 700, the first airfoil cavity 720 is arranged to have a first channel 722, a second channel 724, and a third channel 726. The first channel 722 of the first airfoil cavity 750 is defined as a channel of the first airfoil cavity 750 defined between the baffle 720 and a pressure side interior surface of the airfoil body 702. The second channel 724 of the first airfoil cavity 750 is defined as a channel of the first airfoil cavity 750 defined between the baffle 720 and a suction side interior surface. Aft of the baffle 720 and forward of the impingement rib 754, the first channel 722 and the second channel 724 merge to form the third channel 726, which is defined between the pressure side interior surface and the suction side interior surface. The third channel 726 is defined by the airfoil body 702 having increased wall thickness forward of the impingement rib and aft of the location where the baffle 720 in installed, in order to minimize or reduce a channel height of the third channel 726.

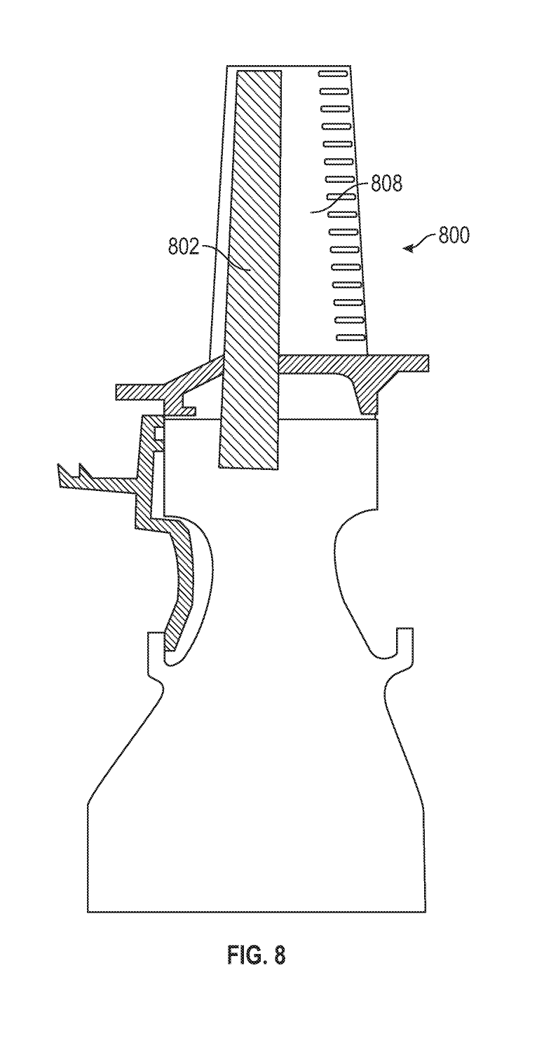

Turning now to FIG. 8, an airfoil 800 is shown with a restricted baffle 802 installed therein. In this embodiment, the baffle 802 may be restricted because of the position and orientation of a platform, rails, or due to any other considerations. Due to the restriction, the airfoil 800 includes a modified airfoil cavity region 808 aft of the baffle that includes increased wall thickness airfoil body walls, similar to that shown and described above. It is noted that in the illustration of FIG. 8, the airfoil 800 is a blade. That is, although shown and described above with respect to vanes, embodiments of the present disclosure can be implemented within blades as well.

Advantageously, embodiments described herein provide cooling configurations for airfoil cavities containing a baffle. For example, in airfoil arrangements having an axially constrained baffle, embodiments provided herein can improve part life. In the region that the baffle cannot extend further, e.g., typically axially-aft, the wall thickness of the airfoil is increased in order to reduce the channel height. Advantageously, such reduced channel height will increase coolant Mach numbers, increase the convective heat-transfer coefficient, and can also reduce pressure loss.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. An airfoil for a gas turbine engine, the airfoil comprising:
an airfoil body, the body extending between a leading edge and a trailing edge in an axial direction and between a pressure side wall and a suction side wall in a circumferential direction, the airfoil body defining an airfoil cavity therein; and
a baffle located within the airfoil cavity,
wherein the airfoil cavity includes:
a first channel defined between the baffle and a pressure side interior surface of the airfoil body, wherein the first channel has a first channel height H₁ defined as a distance between the baffle and the pressure side interior surface,
a second channel defined between the baffle and a suction side interior surface of the airfoil body, wherein the second channel has a second channel height H₂ defined as a distance between the baffle and the suction side interior surface, and
a third channel aft of the baffle and defined between the pressure side interior surface and the suction side interior surface, wherein the third channel has a third channel height H₃ defined as a distance between the pressure side interior surface and the suction side interior surface, and
wherein a trailing edge of the baffle has a height H₄, wherein
$$\frac{{H}_{4}}{( 0.5 * ( {H}_{1} + {H}_{2} ) )} > 3.$$

2. The airfoil of claim 1, wherein the airfoil body has a first wall thickness T₁, a second wall thickness T₂, a third wall thickness T₃, and fourth wall thickness T₄, wherein the first wall thickness is a portion of the airfoil body defining the first channel, the second wall thickness is a portion of the airfoil body defining the second channel, and the third and fourth wall thicknesses are portions of the airfoil body defining the third channel.

3. The airfoil of claim 2, wherein at least one of
$$\frac{{T}_{3}}{{T}_{1}} and \frac{{T}_{4}}{{T}_{2}}$$
is between 1.25 and 3.

4. The airfoil of claim 2, wherein the at least one of the pressure side wall and the suction side wall includes a wall transition section located between portions of the airfoil defining the respective first channel or second channel and the third channel.

5. The airfoil of claim 1, wherein
$$\frac{{H}_{3}}{( {H}_{1} + {H}_{2} )}$$
is between 0.5 and 1.5.

6. The airfoil of claim 1, wherein the third channel has smooth walls on both the pressure and suction sides of the third channel.

7. The airfoil of claim 6, wherein
$$\frac{{H}_{3}}{( {H}_{1} + {H}_{2} )}$$
is between 0.5 and 1.2.

8. The airfoil of claim 1, wherein the third channel has at least one heat transfer augmentation feature on one of the pressure side wall and the suction side wall defining the third channel.

9. The airfoil of claim 8, wherein
$$\frac{{H}_{3}}{( {H}_{1} + {H}_{2} )}$$
is between 0.75 and 1.25.

10. The airfoil of claim 1, wherein the third channel has at least one heat transfer augmentation feature on each of the pressure side wall and the suction side wall defining the third channel.

11. The airfoil of claim 10, wherein
$$\frac{{H}_{3}}{( {H}_{1} + {H}_{2} )}$$
is between 1.0 and 1.5.

12. The airfoil of claim 1, wherein the airfoil cavity having the baffle is a first airfoil cavity, the airfoil body further defining a second airfoil cavity.

13. The airfoil of claim 12, wherein the second airfoil cavity is located aft of the first airfoil cavity and separated therefrom by an impingement rib.

14. The airfoil of claim 13, wherein the third channel is located between the baffle and the impingement rib.

15. The airfoil of claim 1, wherein the airfoil body defines a body of a vane of a gas turbine engine.

16. The airfoil of claim 1, wherein the airfoil body defines a body of a blade of a gas turbine engine.

17. A gas turbine engine comprising:
a turbine section having a blade and a vane, wherein at least one of the blade and the vane includes:
an airfoil body, the body extending between a leading edge and a trailing edge in an axial direction and between a pressure side and a suction side in a circumferential direction, the airfoil body defining an airfoil cavity therein; and
a baffle located within the airfoil cavity,
wherein the airfoil cavity includes:
a first channel defined between the baffle and a pressure side interior surface of the airfoil body, wherein the first channel has a first channel height H₁ defined as a distance between the baffle and the pressure side interior surface,
a second channel defined between the baffle and a suction side interior surface of the airfoil body, wherein the second channel has a second channel height H₂ defined as a distance between the baffle and the suction side interior surface, and
a third channel aft of the baffle and defined between the pressure side interior surface and the suction side interior surface, wherein the third channel has a third channel height H₃ defined as a distance between the pressure side interior surface and the suction side interior surface, and
wherein a trailing edge of the baffle has a height H₄, wherein
$$\frac{{H}_{4}}{( 0.5 * ( {H}_{1} + {H}_{2} ) )} > 3.$$

18. The gas turbine engine of claim 17, wherein the airfoil body has a first wall thickness T₁, a second wall thickness T₂, a third wall thickness T₃, and fourth wall thickness T₄, wherein the first wall thickness is a portion of the airfoil body defining the first channel, the second wall thickness is a portion of the airfoil body defining the second channel, and the third and fourth wall thicknesses are portions of the airfoil body defining the third channel, and wherein at least one of
$$\frac{{T}_{3}}{{T}_{1}} and \frac{{T}_{4}}{{T}_{2}}$$
is between 1.25 and 3.

19. The gas turbine engine of claim 18, wherein the at least one of the pressure side wall and the suction side wall includes a wall transition section located between portions of the airfoil defining the respective first channel or second channel and the third channel.

20. The gas turbine engine of claim 17, wherein
$$\frac{{H}_{3}}{( {H}_{1} + {H}_{2} )} = \{ \begin{matrix}0.5 to 1.2 , smooth walls of the third channel \\ 0.75 to 1.25 , features on one wall of the third channel \\ 1.0 to 1.5 , features on both walls of the third channel\end{matrix} .$$
